(19) United States
(12) Patent Application Publication
(10) Pub. No.: US 2008/0271272 A1
(43) Pub. Date: Nov. 6, 2008

(54) Apparatus for Cleaning Textiles and Method of Using the Same

(75) Inventor: Zefferino Righetto, Mira VE (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 11/571,856

(22) PCT Filed: Jul. 11, 2005
(86) PCT No.: PCT/GB05/02715

§ 371 Date: Oct. 31, 2007

(30) Foreign Application Priority Data
Jul. 10, 2004 (GB) 0415516.4

(51) Int. Cl. A47L 11/32; B08B 7/04

(52) U.S. Cl. 15/41.1; 134/18

(57) ABSTRACT

A cleaning device comprises a cleaning composition container (10) and a dispensing section (12), wherein the dispensing section (12) is operable to eject an amount of cleaning composition from the cleaning composition container (10), and wherein the dispensing section (12) comprises a plurality of projections (14) adapted to work the cleaning composition into an item to be cleaned.

This invention relates to apparatus for cleaning textiles, including carpets, clothing and fabrics and to a method of operating said apparatus.

Compositions exist for cleaning stains, spills and the like from carpets, clothing and other fabrics and textile materials. However, problems arise in the relation to the use of these compositions in that simply spraying the material onto a fabric or carpet and then rubbing the composition into the stain with a cloth does not give consistent results and does not make for best use of the compositions provided. Carpets have a high hydrophobicity that makes it difficult to a cleaning composition to act on fibres, because the cleaning composition is repelled by coatings on the fibres (whether that is the build up of dirt or stain repellant treatments present on the fibres).

It is an object of the present invention to address the above mentioned disadvantages.

According to a first aspect of the present invention there is provided a cleaning device having a cleaning composition container and a dispensing section, wherein the dispensing section is operable to eject an amount of cleaning composition from the cleaning composition container, and wherein the dispensing section comprises a plurality of projections adapted to work the cleaning composition into an item to be cleaned.

The cleaning device may be a textiles cleaning device, which is preferably adapted for use with textiles materials such as carpets, upholstery, fabrics and/or other materials with a pile.

The projections preferably extend generally parallel to one another. The projections are preferably the same length. The projections preferably terminate on substantially the same plane.

The dispensing section may have a peripheral rim, which preferably terminates at substantially the same plane as the projections.

At least some of the projections may be nozzles, preferably adapted to deliver the cleaning composition through channels therein. Preferably all the projections are nozzles. Preferably there is >1, >3, >5, >7 or >10 nozzles. Ideally these are <15, <13, <11, <9 or <8 nozzles.

At least some of the projections are made of a pliable, or flexible, material, which advantageously enhances the ability of the projections to work the cleaning composition into the item to be cleaned.

At least some of the projections may be bristles, preferably collections of bristles.

The cleaning device may be a handheld cleaning device. The cleaning device may be adapted to be held in two hands.

The cleaning device may incorporate a handle section. The handle section may contain the cleaning composition container. The cleaning composition container may be accessible by a door section. Alternatively, the cleaning composition container may be secured to an exterior of the handle section.

The handle section may be moveable relative to the dispensing section, which may be by means of a pivotable joint between the two.

The dispensing section may be adapted for reciprocal movement, preferably with respect to the cleaning composition container. The reciprocal movement may be a circular or back and forth movement, which may be an oscillating movement, preferably adapted to oscillate the projections relative to the article to be cleaned. The cleaning device preferably includes a switch operable to selectively activate or deactivate the reciprocal movement of the dispensing section. The movement of the head section advantageously improves the ability of the device to work a cleaning composition into a material to be cleaned. In particular where a fabric has a pile, the nozzles can penetrate the pile and inject the cleaning composition below the surface of the pile to thereby reduce the problem encountered in wetting pile fabrics due to surface treatments applied thereto.

The cleaning device may include a switch operable to selectively activate or deactivate a supply of the cleaning composition to the dispensing section.

The cleaning composition container may be an aerosol container. The cleaning composition container may be a pouch, preferably having at least one flexible wall. The pouch preferably has an output valve. The pouch may contain a cleaning composition in a gel formulation. The pouch may be adapted to eject an amount of cleaning composition therefrom on application of pressure by a user, said pressure may result from a user gripping the pouch.

According to a second aspect of the invention there is provided a cleaning composition container as described in relation to the first aspect, the cleaning composition container being adapted for use with a dispensing section as described in the first aspect.

The dispensing section may have a handle section attached thereto. Said handle section may be adapted to receive the cleaning composition container therein.

According to a third aspect of the present invention there is provided a method of cleaning a textiles material comprising placing projections of a dispensing section of a cleaning device on a textiles material to be cleaned, dispensing an amount of cleaning composition onto or into the material to be cleaned, and moving the projections relative to the textiles material, to thereby work the cleaning composition into the textiles material.

The reference to textiles material should be taken to include materials such as those having a pile (including rugs of any sort), carpets, upholstery and fabrics, including clothing fabrics and materials. Preferably the textile material is carpet.

The cleaning composition may be dispensed into a pile of the textiles material.

The cleaning composition may be dispensed from the projections, preferably substantially from ends thereof (ideally by means of channels that are in fluid communication with the cleaning composition container). The channels connecting the exits of the nozzles to the cleaning composition container preferably meet together at a manifold. Thereby, ideally a lower number (preferably one) of channels connect from the cleaning composition container to the channels connected to the nozzles through the manifold.

The cleaning composition may be dispensed by pushing the cleaning composition container towards the dispensing section. The cleaning composition may be dispensed by operation of a switch.

The projections may be moved by means of oscillating the dispensing section relative to a handle section of the cleaning device.

According to a fourth aspect of the present invention there is provided a method of cleaning comprising using a cleaning composition container as described in the second aspect or a cleaning device of the first aspect for the method of the fourth aspect.

All of the features described herein may be combined with any of the above aspects, in any combination.

For a better understanding of the invention, and to show how embodiments of the same may be carried into effect, reference will now be made, by way of example, to the accompanying diagrammatic drawings in which:

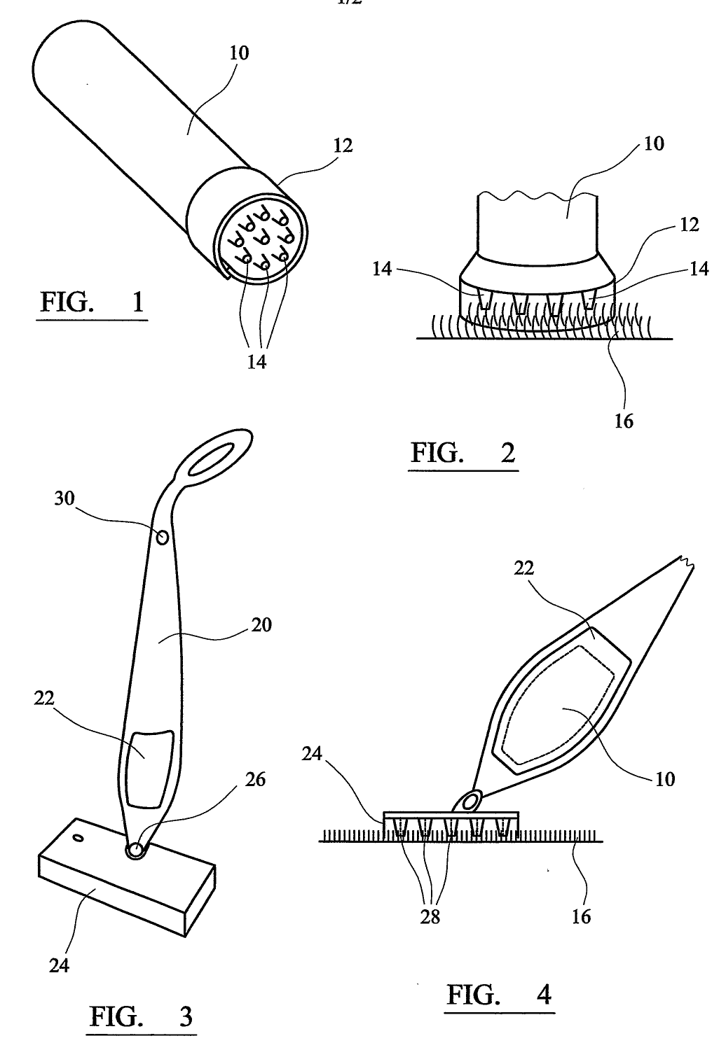

FIG. 1 is a schematic perspective view of a textiles cleaning device showing output nozzles on a lower end thereof;

FIG. 2 is a partially cut away schematic side view of the cleaning device shown in FIG. 1 in use;

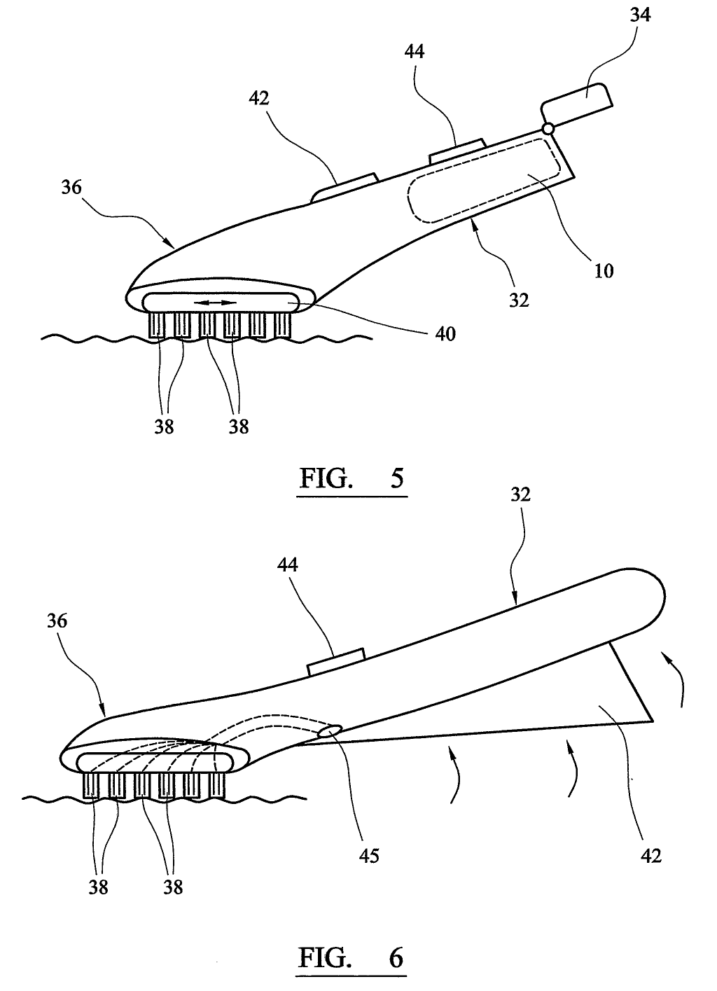

FIGS. 3 and 4 are schematic perspective and partial cross-sectional side views of a second embodiment of cleaning device;

FIG. 5 is a schematic side view of a third embodiment of cleaning device; and

FIG. 6 is a schematic side view of a fourth embodiment of cleaning device.

FIGS. 1 and 2 show a cleaning device comprising a cleaning composition container 10 and a dispensing head 12. The dispensing head 12 incorporates a plurality of dispensing nozzles 14 through which cleaning composition from the cleaning composition container 10 is dispensed. The dispensing nozzles 14 are flexible and may be made of a plastics material having some flexibility or a rubber-type material.

In use, a user grasps the cleaning composition container 10 and pushes it towards and into a carpet 16 to be cleaned. The dispensing nozzles 14 penetrate slightly into the pile of the carpet 16 as shown in FIG. 2. When the user exerts sufficient pressure an amount of cleaning composition from the cleaning composition container 10 is ejected from the dispensing nozzles 14 into the pile of the carpet 16.

The cleaning composition is dispensed into the carpet 16 and turns into a foam and expands back up to the surface of the carpet 16 lifting any dirt and stains as it expands. The device has advantages for use on small-scale stains, given its small size.

The composition envisaged is the applicant's Vanish® formulation. The formulation is a quick dry formulation and any residues quickly turn to a powder. A user may then suitably remove the powder residue with a vacuum cleaner or the like.

This first embodiment of cleaning device has significant advantages in that the cleaning composition is delivered beneath the surface of the pile of the carpet 16. Thus, excellent penetration of the cleaning product is achieved. Also, stains and dirt are not driven downwards into the carpet as the material expands. Instead since it is applied beneath the surface of the carpet the foam and captured waste material is allowed to rise upwards and carry the stain with it for subsequent removal. Also, at the same time movement of the cleaning device by the user causes the nozzles to loosen and capture or dissolve a stain that is being cleaned.

The cleaning composition can also be used with other types of textile material, or fabrics with a pile, or upholstery material.

Additional benefits from the penetration of the dispensing nozzles 14 into the textile or fabric material to be cleaned is that cleaning within the fabric is effected, rather than just on the surface thereof. The formulation of the cleaning composition allows the cleaning of stains such as red wine, pet stains, coffee and tomato sauce.

FIGS. 3 and 4 show a second embodiment of cleaning device. The cleaning device comprises a handle 20 which incorporates an opening hatch 22 for a receipt of cleaning composition container 10. As can be seen, the same reference numeral for the cleaning composition container 10 has been used as in relation to the first described embodiment. This is because the same type of cleaning composition container 10 can be used. The container is an aerosol-type container and contains the applicant's Vanish® cleaning composition. Other parts in common with the first embodiment also have the same reference numerals.

The handle 20 is attached to a head section 24 by means of a ball and socket joint 26. The head section 24 incorporates nozzles 28 through which cleaning composition from the cleaning composition container 10 is dispensed. The nozzles 28 are in the form of nodules which may be made of rubber and may be made of another material having pliant characteristics. The cleaning composition may alternatively be ejected from a part of the head section 24 other than the nozzles 28, such as to the side thereof. The use of a pliant material allows the second embodiment of cleaning device to be worked into a carpet 16 to allow the nozzles 28 to penetrate the pile of the carpet 16 to allow the cleaning composition from the cleaning composition container 10 to be injected into the pile, rather than onto the surface of the pile.

Such a method of application has advantages in that carpets very often have very strong hydrophobic characteristics which prevent the mixing of cleaning compositions and penetration of cleaning compositions into carpet materials. Thus, penetration directly into the pile helps to reduce the hydrophobic characteristics typically present in carpets. Such characteristics can also be exacerbated by the types of coatings that are often applied to carpets in order to reduce staining thereof.

The same advantages as explained in relation to the first embodiment also apply to the second embodiment. In addition this device has advantages for cleaning larger areas including stains, given its larger size and its handle that makes a wider scale application easier to perform.

In use, a user presses a button 30 on the handle 20 causing cleaning composition from the cleaning composition 10 to be transferred to the cleaning head 26 and into the dispensing nozzles 28. The user works the cleaning device so that the cleaning head 24 moves allowing the nozzles 28 to penetrate the carpet pile allowing better penetration of the cleaning composition.

As described in relation to the first embodiment the cleaning composition forms a foam which then dries and can be removed, for example by a vacuum cleaner.

FIG. 5 shows a third embodiment of cleaning device. The device incorporates a handle section 32 with a lid 34 located at an end of the handle section 32, in which handle section 32 a cleaning composition container 10 is received. A head section 36 of the cleaning device forms a brush head having collections of bristles 38. The bristles may be replaced by nozzles as described in relation to the device of FIGS. 1 and 2, in which case the cleaning composition can advantageously be worked into a material to be cleaned, for example, below a pile surface of a material having a pile. The bristles 38 are mounted to have an oscillating action by means of an oscillating section 40. The oscillating section 40 is powered by a small motor (not shown) and is operated by a switch 42 on the handle section 32. The cleaning composition from the cleaning composition container 10 is dispensed by activation of a switch 44, also located on the handle section 32.

In use, a user loads a cleaning composition container 10 into the end opening in the handle section 32 and closes the lid 34. The user then presses the button 44 to cause cleaning composition to be ejected through the head section 36 and the bristles 38. The user then presses the button 42 to cause the oscillating section 40 to operate causing oscillation of the bristles 38.

The movement of the bristles 38 in conjunction with the cleaning composition ejected from the cleaning device causes the cleaning composition to be worked into a surface to be cleaned. This surface may be a piece of clothing, or alternatively may be a carpet or other textiles materials. The movement of the bristles causes the cleaning composition to be worked into the item to be cleaned. At the same time the movement loosens and dissolves a stain that is being cleaned. The oscillating section 40 has two speeds of operation to allow for different types of item being cleaned.

The advantages of earlier embodiments apply to this embodiment also in that the cleaning composition is delivered to the bristles, which have some equivalence of function with the nozzles described in relation to the first and second embodiments. In particular, projections from the cleaning head in all of the embodiments allow the cleaning composition to be ejected closer to and into the item to be cleaned, rather than just simply spraying or applying the material from a distance away from the item to be cleaned.

The third embodiment has advantages in cleaning fabrics and other textile materials with less pile than that of a carpet in that the flexible bristles 38 allow better working of the cleaning composition into the fabric. In the case of carpets with a pile or other pile materials the fibres of the pile flex and are moved to one side of the nozzles, which is less easily achieved with a fabric with little or no pile, such as a clothing fabric.

The ejection of the cleaning material from the cleaning composition container 10 may be a manual activation, whereas the oscillating section 40 is powered by a battery (not shown).

A fourth embodiment of cleaning device is shown in FIG. 6. The embodiment has a number of parts in common with the third embodiment and like reference numerals are used for those common parts.

A handle section 32 carries a button 34 for activation of an oscillating section 40 of a head section 36. In a difference compared to the third embodiment, the fourth embodiment has a pouch 42 for containing a cleaning composition, which may be the applicant's Vanish® gel product. The pouch 42 is operated in a bellows-type arrangement in which a user simply holds the handle 32 and squeezes the pouch 42 to cause cleaning composition to be ejected from the pouch 42 via a valve 44 and into the head section 36 and on through to the bristles 38 to a fabric or other textile material to be cleaned.

The fourth embodiment has the same oscillating section 40 which causes the bristles 38 to move and work the cleaning composition into the fabric or other textile material being cleaned. Consequently, the functional cleaning advantages mentioned in relation to the third embodiment also apply to the fourth embodiment. However, an alternative type of cleaning composition is provided for the fourth embodiment compared to the third embodiment.

The device is used in much the same way in that the cleaning composition is worked into a fabric or textile material to be cleaned with the bristles 38 working composition well into the material.

All of the embodiments described above have the benefit of ejecting material from a hand held cleaning device into a textile material or fabric. The cleaning composition is ejected close to the surface of the item being cleaned or even inside the item being cleaned in the case of materials with piles such as carpets or knitted items. A user can work the cleaning composition into the item being cleaned for better penetration thereof compared to cleaning compositions that are simply applied to the surface of an item being cleaned.

The cleaning composition used may be any of those suitable for cleaning stains in carpets or fabrics etc. The products may be in the form of a gel, a liquid, a powder (which may be compressed), or any other suitable type that can be dispensed.

A superwetting agent can be added to overcome the problem associated with the high repellency of carpet to water. This is primarily caused from two sources, the first being the amount of soiling which can accumulate on carpets and, secondly, the prevalence of stain repelling treatments, which are increasingly commonly applied to carpets either during manufacture or by the consumer. In this invention a super wetting agent is a special surfactant added at levels of below 10% w/w of the composition, preferably below 9, 8, 7, 6 or 5% w/w, of the composition, that can, combined with any other surfactant present in the composition, is able to lower the surface tension of the final diluted liquid cleaning formulation to values below 28 mN/m, when 10 g is dissolved in 4 litres of water.

Preferably a product is used having from 50 and 500 ml of liquid carpet cleaning composition per device, ideally from 100 to 250 ml.

### Builders

The cleaning composition comprises at least one builder active or a combination of builders from 0.1 to 90% w/w, preferably from 0.1 to 50% w/w. Preferably the builder is soluble or miscible with the cleaning composition.

Suitable carboxylate compounds are used and include the monomeric polycarboxylates, or their acid forms and polymeric polycarboxylic acids or their salts. Polymeric polycarboxylic acids are preferred for the reasons given above, in terms of protecting the water-soluble polymer.

The carboxylate builder can be monomeric or polymeric in type, monomeric polycarboxylates are generally preferred for reasons of cost and performance.

Suitable and preferred polymeric polycarboxylic acids are iminosuccinic acid or polyaspartic acid, mixtures thereof or their metal/amino salts. Examples of these polymers are Baypure CX 100/34 and Baypure DS 100/40 supplied from Bayer.

Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447.

Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates containing sulfo suibstituents include the sulfosuccinate derivatives disclosed in GB-A-1,398,421, GB-A-1,398,422 and U.S. Pat. No. 3,936,448, and the sulfonated pyrolsed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane-hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates.

More preferred are the polymer builders, i.e. polymeric polycarboxylic acid, which are homo-polymers, copolymers and multiple polymers of acrylic, flourinated acrylic, sulfonated styrene, maleic anhydride, metacrylic, iso-butylene, styrene and ester monomers. Examples of these polymers are Acusol supplied from Rohm & Haas, Syntran supplied from Interpolymer and Versa and Alcosperse series supplied from Alco Chemical, a National Starch & Chemical Company.

Suitable builders are bicarbonates, sesquicarbonates, borates, phosphates, phosphonates, and mixtures of any of thereof.

Water-soluble phosphonate and phosphate builders are useful for this invention. Examples of phosphate buiders are the alkali metal tripolyphosphates, sodium potassium and ammonium pyrophosphate, sodium and potassium and ammonium pyrophosphate, sodium and potassium orthophosphate sodium polymeta/phosphate in which the degree of polymerisation ranges from 6 to 21, and salts of phytic acid.

Specific examples of water-soluble phosphate builders are the alkali metal tripolyphosphates, sodium potassium and ammonium pyrophosphate, sodium and potassium and ammonium pyrophosphate, sodium and potassium orthophosphate, sodium polymeta/phosphate in which the degree of polymerization ranges from 6 to 21, and salts of phytic acid.

Examples of bicarbonate and carbonate builders are the alkaline earth and the alkali metal carbonates, including sodium carbonate and sesqui-carbonate and mixtures thereof. Other examples of carbonate type builders are the metal carboxy glycine and metal glycine carbonate.

### Surfactants

Examples of surfactants considered in this invention are either anionic, non-ionic or cationic. Preferred total levels of surfactant are from 0.1 to 70% w/w, ideally from 1 to 30% wt and preferably between 5 to 20% w/w.

Examples of non-ionic surfactant are described in the formula RO(CH2CH2O)nH wherein R is a mixture of linear, even carbon-number hydrocarbon chains ranging from C12H25 to C16H33 and n represents the number of repeating units and is a number of from about 1 to about 12. Examples of other non-ionic surfactants include higher aliphatic primary alcohols containing about twelve to about 16 carbon atoms which are condensed with about three to thirteen moles of ethylene oxide.

Other examples of non-ionic surfactants include primary alcohol ethoxylates (available under the Neodol tradename from Shell Co.), such as C11 alkanol condensed with 9 moles of ethylene oxide (Neodol 1-9), C12-13 alkanol condensed with 6.5 moles ethylene oxide (Neodol 23-6.5), C12-13 alkanol with 9 moles of ethylene oxide (Neodol 23-9), C12-15 alkanol condensed with 7 or 3 moles ethylene oxide (Neodol 25-7 or Neodol 25-3), C14-15 alkanol condensed with 13 moles ethylene oxide (Neodol 45-13), C9-11 linear ethoxylated alcohol, averaging 2.5 moles of ethylene oxide per mole of alcohol (Neodol 91-2.5), and the like.

Other examples of non-ionic surfactants suitable for use in the present invention include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C11-15 secondary alkanol condensed with either 9 moles of ethylene oxide (Tergitol 15-S-9) or 12 moles of ethylene oxide (Tergitol 15-S-12) marketed by Union Carbide, a subsidiary of Dow Chemical.

Octylphenoxy polyethoxyethanol type non-ionic surfactants, for example, Triton X-100, as well as amine oxides can also be used as a non-ionic surfactant in the present invention.

Other examples of linear primary alcohol ethoxylates are available under the Tomadol tradename such as, for example, Tomadol 1-7, a C11 linear primary alcohol ethoxylate with 7 moles EO; Tomadol 25-7, a C12-C15 linear primary alcohol ethoxylate with 7 moles EO; Tomadol 45-7,a C14-C15 linear primary alcohol ethoxylate with 7 moles EO; and Tomadol 91-6, a C9-C11 linear alcohol ethoxylate with 6 moles EO.

Amine oxides can also be used as the non-ionic surfactant of the present invention. Exemplary useful amine oxide compounds may be defined as one or more of the following of the four general classes:

(1) Alkyl di (lower alkyl) amine oxides in which the alkyl group has about 6-24, and preferably 8-18 carbon atoms, and can be straight or branched chain, saturated or unsaturated. The lower alkyl groups include between 1 and 7 carbon atoms, but preferably each include 1-3 carbon atoms. Examples include octyl dimethyl amine oxide, lauryl dimethyl amine oxide, myristyl dimethyl amine oxide, and those in which the alkyl group is a mixture of different amine oxides, such as dimethyl cocoamine oxide, dimethyl (hydrogenated tallow) amine oxide, and myristyl/palmityl dimethyl amine oxide;

(2) Alkyl di (hydroxy lower alkyl) amine oxides in which the alkyl group has about 6-22, and preferably 8-18 carbon atoms, and can be straight or branched chain, saturated or unsaturated. Examples include bis-(2-hydroxyethyl) cocoamine oxide, bis(2-hydroxyethyl) tallowamine oxide; and bis-(2-hydroxyethyl) stearylamine oxide;

(3) Alkylamidopropyl di(lower alkyl) amine oxides in which the alkyl group has about 10-20, and preferably 12-16 carbon atoms, and can be straight or branched chain, saturated or unsaturated. Examples include cocoamidopropyl dimethyl amine oxide and tallowamidopropyl dimethyl amine oxide; and

(4) Alkylmorpholine oxides in which the alkyl group has about 10-20, and preferably 12-16 carbon atoms, and can be straight or branched chain, saturated or unsaturated.

Useful anionic surfactant are frequently provided in a salt form, such as alkali metal salts, ammonium salts, amine salts, amino alcohol salts or magnesium salts. Contemplated as useful are one or more sulfate or sulfonate compounds including: alkyl sulfates, alkyl ether sulfates, alkylamidoether sulfates, alkyl benzene sulfates, alkyl benzene sulfonates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl carboxylates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other examples of anionic surfactants are also alkyl naphthalene sulfonate anionic surfactants of the formula:

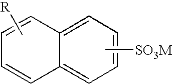

wherein R is a straight chain or branched alkyl chain having from about 1 to about 25 carbon atoms, saturated or unsaturated, and the longest linear portion of the alkyl chain is 15 carbon atoms or less on the average, M is a cation which makes the compound water soluble especially an alkali metal such as sodium or magnesium, ammonium or substituted ammonium cation.

Other examples are alkyl sarcosinate, sulfosuccinate and alkyl sulfate anionic surfactants of the formula

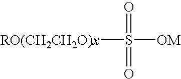

wherein R is a straight chain or branched alkyl chain having from about 8 to about 18 carbon atoms, saturated or unsaturated, and the longest linear portion of the alkyl chain is 15 carbon atoms or less on the average, M is a cation which makes the compound water soluble especially an alkali metal such as sodium or magnesium, ammonium or substituted ammonium cation, and x is from 0 to about 4. Most preferred are the non-ethoxylated C12-15 primary and secondary alkyl sulfates, especially sodium lauryl sulfate.

Most desirably, the anionic surfactant according to constituent is selected to be of a type that dries to a friable powder. This facilitates their removal from carpets and carpet fibres, such as by brushing or vacuuming.

The cationic surfactants of the invention are quaternary ammonium salts which may be characterised by the general structural formula:

[CNR1R2R3R4]⁺

wherein R1, R2, R3 and R4 are independently selected from alkyl, aryl or alkylaryl substituent of from 1 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl and arylalkyl. The remaining substituents on the nitrogen atoms other than the above mentioned alkyl substituents are hydrocarbons usually containing no more than 12 carbon atoms. The substituents R1, R2, R3 and R4 may be straight-chained or may be branched, but are preferably straight-chained, and may include one or more amide, ether or ester linkages.

The counterion X- are selected from halogens anions, saccharinate, alkyl and alkyl benzene sulfate, sulfonate and fatty acid.

### Super Wetting Agents

The super wetting agents of this invention are present at levels of from 0.1 to 10% w/w, ideally 0.5 to 5% w/w, and are selected from silicone glycol copolymers and fluorosurfactants.

The silicone glycol copolymers are described by the following formula:

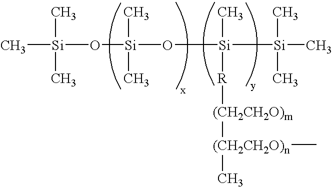

Where X, Y, m and n are whole number ranging from 0 to 25. X is preferably between 0 to 10 and Y, m and n between 0 to 5. R and R′ are straight chain or branched alkyl chain having from about 1 to 25 carbon atoms, saturated or unsaturated, and the longest linear portion of the alkyl chain is on average 15 carbon atoms or less.

The fluorinated surfactant is described in the following formulae:

F(CF₂)ₙ—N(CH3)(CH2)3-(CH₂CH₂O)ₓOSO₂M

F(CF₂)ₙ—N(CH3)(CH2)3-(CH₂CH₂O)ₓOSO₂M

CF₃(CF₂CF₂)ₙ(CFCF)ₘ—(CH₂CH₂O)ₓ—OPO₃M₂

Wherein n, m and x are integers having a value from 0 to 15; preferred values are between 1 and 12. M is a cation which is capable of making the compound water-soluble, especially an alkali metal such as sodium or magnesium or an ammonium or substituted-ammonium cation.

The super wetting agents described are able to lower the surface tension in water at values below 25 mN/m at a concentration less than 0.1% w/v.

Antifoaming agents are an important addition to carpet cleaning compositions of this invention, they are used at a level between 0.01 and 5% w/w. A very high foam level may not allow the carpet cleaning machine to function properly. Antifoaming agents are also considered important components of this invention. Examples are polydimethylsiloxanes, preferably in combination with hydrophobic silica.

### Solvents:

Organic solvents should be water-miscible or water emulsionable. The organic solvent is found at levels of 0.01 to 60% w/v, more preferably between 0.1 to 30% w/w. The organic solvent constituent of the inventive compositions include one or more alcohols, glycols, acetates, ether acetates, glycol ethers and hydrocarbons. Exemplary alcohols useful in the compositions of the invention include C2-C8 primary and secondary alcohols which may be straight chained or branched. Exemplary alcohols include pentanol and hexanol. Exemplary glycol ethers include those glycol ethers having the general structure Ra—O—Rb—OH, wherein Ra is an alkoxy of 1 to 20 carbon atoms, or aryloxy of at least 6 carbon atoms, and Rb is an ether condensate of propylene glycol and/or ethylene glycol having from 1 to 10 glycol monomer units. Preferred are glycol ethers having 1 to 5 glycol monomer units.

By way of further non-limiting example specific organic constituents include propylene glycol methyl ether, dipropylene glycol methyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate and particularly useful is, propylene glycol phenyl ether, ethylene glycol hexyl ether, diethylene glycol hexyl ether. Examples of hydrocarbons solvents are linear and branched, saturated and unsaturated carbon chain with a number of carbon atoms from C4-C40, preferably from C6-C22.

1. A cleaning device comprises a cleaning composition container and a dispensing section, wherein the dispensing section is operable to eject an amount of cleaning composition from the cleaning composition container, and wherein the dispensing section comprises a plurality of projections adapted to work the cleaning composition into an item to be cleaned.

2. A cleaning device as claimed in claim 1, which is a textiles cleaning device

3. A cleaning device according to claim 1, in which the projections extend generally parallel to one another.

4. A cleaning device according to claim 1, in which the projections terminate on substantially the same plane.

5. A cleaning device according to claim 1, in which the dispensing section has a peripheral rim.

6. A cleaning device according to claim 1, in which at least some of the projections are nozzles.

7. A cleaning device according to claim 1, in which at least some of the projections are made of a pliable material.

8. A cleaning device as claimed in claim 6, in which the nozzles are adapted to eject a cleaning composition from ends thereof.

9. A cleaning device according to claim 1, in which the cleaning device is a handheld cleaning device.

10. A cleaning device according to claim 1, in which the cleaning device incorporates a handle section.

11. A cleaning device as claimed in claim 10, in which the handle section contains the cleaning composition container.

12. A cleaning device as claimed in claim 10 in which, the cleaning composition container is secured to an exterior of the handle section.

13. A cleaning device according to claim 10, in which the handle section is movable relative to the dispensing section.

14. A cleaning device according to claim 1, in which the dispensing section is adapted for an oscillating movement.

15. A cleaning device according to claim 1, which includes a switch operable to selectively activate or deactivate a supply of the cleaning composition to the dispensing section.

16. A cleaning device according to claim 1, in which the cleaning composition container is an aerosol container.

17. A cleaning device according to claim 1, in which the cleaning composition container is a pouch.

18. A cleaning composition container adapted for use with a dispensing section of a cleaning device according to claim 1.

19. A method of cleaning a textiles material comprises placing projections of a dispensing section of a cleaning device onto or into a textiles material to be cleaned, dispensing an amount of cleaning composition onto or into the material to be cleaned, and moving the projections relative to the textiles material, to thereby work the cleaning composition into the textiles material.

20. A method as claimed in claim 18, in which the cleaning composition is dispensed into a pile of the textiles material.

21. A method according to claim 18, in which the cleaning composition is dispensed from the projections.

22. A method according to claim 18, in which the cleaning composition is dispensed by pushing the cleaning composition container towards the dispensing section.

23. (canceled)

24. (canceled)

25. (canceled)
